(19) United States
(12) Patent Application Publication
(10) Pub. No.: US 2020/0266452 A1
(43) Pub. Date: Aug. 20, 2020

(54) PRIMARY LITHIUM BATTERY HAVING HIGH DISCHARGE EFFICIENCY

(71) Applicant: HUIZHOU HUIDERUI LITHIUM BETTERY TECHNOLOGY CO., LTD., Guangdong (CN)

(72) Inventors: Xianwen HE, Guangdong (CN); Wenshuo PAN, Guangdong (CN); Zhongfen LAO, Guangdong (CN)

(21) Appl. No.: 16/651,365

(22) PCT Filed: Sep. 29, 2017
(86) PCT No.: PCT/CN2017/104438

§ 371 Date: Mar. 27, 2020

(30) Foreign Application Priority Data
Sep. 27, 2017 (CN) 201710890292.4

(51) Int. Cl. H01M 6/02; H01M 6/14; H01M 2/16; H01M 2/26; H01M 4/06

(52) U.S. Cl. CPC H01M 6/02; H01M 6/14; H01M 4/06; H01M 2/263; H01M 2/1673

(57) ABSTRACT

A primary lithium battery having high discharge efficiency, having a positive electrode plate, a separator, a lithium best negative electrode plate, and electrode tabs disposed on the positive electrode plate and the lithium belt negative electrode plate respectively; the positive electrode plate, the separator, and the lithium belt negative electrode plate are mutually wound together as a winding, wherein an end of the electrode tab of the positive electrode plate is used as a starting end of the winding; at a tad end of the winding, a reaction inhibiting region is provided on the lithium belt negative electrode plate; a polymer plastic tape is provided on the reaction inhibiting region; a groove is provided between the electrode tab of the lithium belt negative electrode plate and the polymer plastic tape to stop reaction.

### BACKGROUND OF THE INVENTION

The present invention relates to the technical field of battery, and more specifically relates to a primary lithium battery having high discharge efficiency.

According to a conventional method of making a primary lithium battery, a width of a reaction interface corresponding to the positive and negative electrodes, including the entire width of the negative electrode, will reduce subsequent to continuous electrochemical reaction and the resulting continuous consumption of lithium metal of the negative electrode. In a later stage of reaction, regions where the negative and the positive electrodes are closely in contact are partially formed as disconnected portions with respect to the negative electrode tabs due to excessive consumption resulting from reaction, As a result, lithium belt of the negative electrode will be broken, and the lithium metal will be partially discontinued from participating in the reaction. Hence, the utility rate of the negative electrode is reduced, and the battery capacity cannot be effectively utilized. Even in cases where the battery capacity can be effectively and sufficiently utilized, overloaded power output will expose the battery under safety risks.

### BRIEF SUMMARY OF THE INVENTION

In view of the aforesaid problems now present in the prior art, the present invention provides a safer primary lithium battery enabling sufficient reaction of the lithium belt and sufficient and effective utilization of the battery capacity.

In order to obtain the above objects, the present invention provides the following technical solutions: A primary lithium battery having high discharge efficiency, comprising a positive electrode plate, a separator, a lithium belt negative electrode plate, and electrode tabs disposed on the positive electrode plate and the lithium belt negative electrode plate respectively; the positive electrode plate, the separator, and the lithium belt negative electrode plate are mutually wound together as a winding, wherein an end of the electrode tab of the positive electrode plate is used as a starting end of the winding; at a tail end of the winding, a reaction inhibiting region is provided on the lithium belt negative electrode plate; a polymer plastic tape is provided on the reaction inhibiting region; a groove is provided between the electrode tab of the lithium belt negative electrode plate and the polymer plastic tape to stop reaction.

Further, in the above-mentioned primary lithium battery having high discharge efficiency, the polymer plastic tape is any one of a polyimide tape, a polyolefin tape, a polyester tape, and a polyfluoro tape; an acrylic glue layer or a silica gel layer is provided between the polymer plastic tape and the lithium belt negative electrode plate; a width of the polymer plastic tape is 10% to 35% of a width of the lithium belt negative electrode plate; preferably, a length of the polymer plastic tape is 10% to 20% of a length of the lithium belt negative electrode plate.

A depth of the groove is 40% to 90% of a thickness of the entire lithium belt negative electrode plate; a width of the groove is 0.1% to 7% of a length of the entire lithium belt negative electrode plate; a length of the groove is the same as or slightly narrower than a width of the lithium belt negative electrode plate.

Further, in the above-mentioned primary lithium battery with high discharge efficiency, the positive electrode plate is made by blending an active material such as manganese dioxide, iron disulfide, etc, a conductive agent, and a binder evenly in a solvent such as deionized water, N-methyl Pyrrolidone NMP and the like to form a mixture, then coating the mixture on a positive electrode current collector, and then drying and laminating. The conductive agent is at least one of graphite and carbon black. The binder is at least one of polytetrafluoroethylene, polyvinylidene, hydroxymethyl cellulose (CMC), styrene-butadiene rubber (SBR), and polyacrylate terpolymer latex; and the polyacrylate terpolymer copolymer latex is for example LA132 and LA135 rubber.

As known, when the positive electrode plate and the negative electrode plate are positioned one over another when making the primary lithium battery, starting end of the winding is an end of the electrode tab of the positive electrode. According to the present invention, a tail end of the winding is provided with a reaction inhibiting region on the lithium belt negative electrode plate, a polymer plastic tape is provided on the reaction inhibiting region, a width of the polymer plastic tape is 10% to 35% of a width of the lithium belt negative electrode plate, a length of the polymer plastic tape is 10% to 20% of a length of the lithium belt negative electrode plate. The reaction inhibiting region of the length and width within the ranges specified above can allow effective and sufficient battery discharge, and can also effectively prevent the lithium belt negative electrode plate from breaking. Also, a groove that stops reaction is provided between the electrode tab of the lithium belt negative electrode plate and the polymer plastic tape. According to the above configurations, the reaction inhibiting region can ensure effective and sufficient battery discharge, while the groove can ensure that the lithium belt negative electrode plate can be broken under overloaded battery discharge or forced battery discharge, thereby ensuring battery safety. Therefore, the primary lithium battery of the present invention is safe and has high discharge capacity.

### BRIEF DESCRIPTION OF THE DRAWINGS

FIG. 1 is a comparative example 1 according to prior art, showing the structural view where the lithium belt negative electrode plate is unfolded.

FIG. 2 is a structural view showing the relative positions of the positive electrode plate and the lithium belt negative electrode plate (also configured with the polymer plastic tape and the groove) unfolded according to embodiments 1, 2 and 3 of the present invention.

FIG. 3 is a structural view showing the relative positions of the positive electrode plate and the lithium belt negative electrode plate (also configured with the polymer plastic tape) unfolded according to a comparative example 2.

In the figures, 1 is positive electrode plate, 2 is lithium belt negative electrode plate, 3 are electrode tabs, 4 is polymer plastic tape, and 5 is groove.

### DETAILED DESCRIPTION OF THE INVENTION

In order that a person skilled in the art can have a better understanding of the technical solutions provided by the present invention, the technical solutions of the present invention will be further described below with reference to the accompanying figures.

### Embodiment 1

As shown in FIG. 2, a primary lithium battery having high discharge efficiency comprises a positive electrode plate 1, a separator, a lithium belt negative electrode plate 2, and electrode tabs 3 disposed on the positive electrode plate and the lithium belt negative electrode plate respectively; the positive electrode plate 1, the separator, and the lithium belt negative electrode plate 2 are mutually wound together as a winding, wherein an end of the electrode tab of the positive electrode plate is used as a starting end of the winding; at a tail end of the winding, a reaction inhibiting region is provided on the lithium belt negative electrode plate 2; a polymer plastic tape 4 is provided on the reaction inhibiting region; a groove 5 is provided between the electrode tab 3 of the lithium belt negative electrode plate 2 and the polymer plastic tape 4 to stop reaction. The positive electrode plate is made according to the following steps: weighing 1843 g of heat-processed electrolytic manganese dioxide, 37 g of graphite, 120 g of conductive carbon black, and 72 g of polytetrafluoroethylene solution; stirring the above ingredients evenly in deionized water to obtain a mixture, coating the mixture on a 0.3 mm aluminum mesh; drying and laminating the aluminum mesh; cutting the aluminum mesh and welding an electrode tab to the aluminum mesh to form the positive electrode plate 1 as shown in FIG. 2. Length×width of the polymer plastic tape 4 is 35 mm×6 mm, and length×width of the lithium belt negative electrode plate 2 is 240 mm×25 mm. A length of the groove is 25 mm, and a depth of the groove 5 is 40% to 90% of a thickness of the entire lithium belt negative electrode plate. A width of the groove 5 is 0.1% to 7% of the length of the entire lithium belt negative electrode plate.

### Embodiment 2

The positive electrode plate 1 is made according to the method in embodiment 1. According to the positions indicated in FIG. 2, length×width of the polymer plastic tape 4 is 25 mm×4 mm. Length×width of the lithium belt negative electrode plate is 240 mm×25 mm. Length of the groove is 25 mm. Depth of the groove is 40% to 90% of a thickness of the entire lithium belt negative electrode plate. Width of the groove 5 is 0.1% to 7% of the length of the entire lithium belt negative electrode plate.

### Embodiment 3

The positive electrode plate 1 is made according to the method in embodiment 1. According to the positions indicated in FIG. 2, length×width of the polymer plastic tape 4 is 30 mm×8 mm. Length×width of the lithium belt negative electrode plate is 240 mm×25 mm. Length of the groove is 25 mm. Depth of the groove is 40% to 90% of a thickness of the entire lithium belt negative electrode plate. Width of the groove 5 is 0.1% to 7% of the length of the entire lithium belt negative electrode plate.

### Comparative Example 1

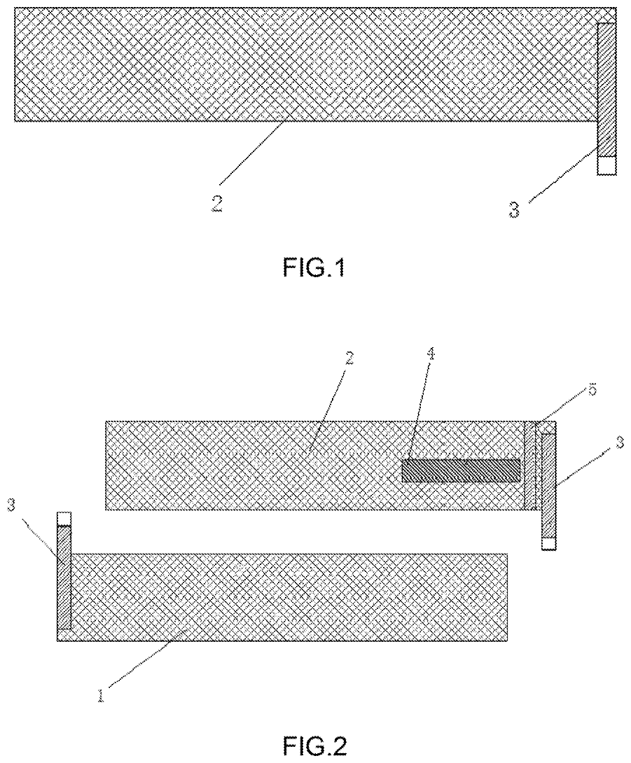

A Li—Mn battery, comprising a positive electrode plate 1, a lithium belt negative electrode plate 2 and an electrode tab 3 provided on the positive electrode plate. The positive electrode plate and the lithium negative electrode plate are wound together to form a winding. The lithium belt negative electrode plate unfolded according to this comparative example 1 is shown in FIG. 1. The lithium belt negative electrode plate does not have reaction inhibiting region or groove that stops reaction.

### Comparative Example 2

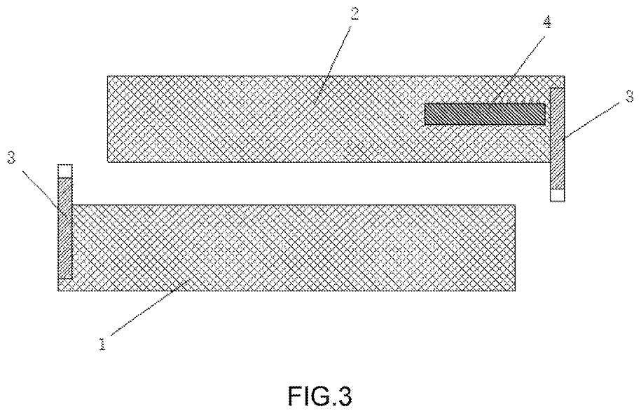

A reaction inhibiting region is provided on the lithium belt negative electrode plate. A polymer plastic tape 4 is adhered to the reaction inhibiting region. However, groove 5 that stops reaction is not provided on the lithium belt negative electrode plate. The comparative example 2 is shown in FIG. 3.

The lithium belt negative electrode plates according to embodiments 1, 2, 3 and comparative examples 1 and 2 are each being used to make a respective cylindrical primary Li—Mn battery.

Tables 1 and 2 below show some experimental results of the embodiments and the comparative examples.

TABLE 1
Comparison of battery capacities of
CR17345 cylindrical Li—Mn batteries

| | 20 mA discharge capacity | | | |
|---|---|---|---|---|
| | AVE | MIN | Uniformity | |
| Experiment | (mAh) | (mAh) | (%) | Result |
| Embodiment 1 | 1543 | 1481 | 91.64 | Higher average |
| Embodiment 2 | 1523 | 1481 | 95.14 | discharge capacity, |
| Embodiment 3 | 1518 | 1478 | 94.66 | good uniformity |
| Comparative | 1483 | 1379 | 88.74 | At later stage, |
| example 1 | | | | some parts of the |
| | | | | battery lithium |
| | | | | belt broken; |
| | | | | lower average |
| | | | | discharge |
| | | | | capacity; poor |
| | | | | uniformity |
| Comparative | 1518 | 1478 | 94.66 | Higher average |
| example 2 | | | | discharge |
| | | | | capacity, good |
| | | | | uniformity |

TABLE 2
Comparison of battery safety of CR17345
cylindrical Li—Mn batteries

| | | Discharge | Discharge | |
|---|---|---|---|---|
| | Forced | 50% over- | 70% over- | |
| Experiment | discharge | loaded | loaded | Result |
| Embodiment 1 | Pass | Pass | Pass | Section the |
| | | | | lithium belt |
| | | | | negative |
| | | | | electrode plate, |
| | | | | and it is broken |
| | | | | at the groove |
| Embodiment 2 | Pass | Pass | Pass | Section the |
| | | | | lithium belt |
| | | | | negative |
| | | | | electrode plate, |
| | | | | and it is broken |
| | | | | at the groove |
| Embodiment 3 | Pass | Pass | Pass | Section tire |
| | | | | lithium belt |
| | | | | negative |
| | | | | electrode plate. |
| | | | | and it is broken |
| | | | | at the groove |
| Comparative | Pass | Pass | Pass | Section the |
| example 1 | | | | battery, and the |
| | | | | inner lithium |
| | | | | belt is broken |
| | | | | at a position |
| | | | | corresponding to |
| | | | | a tail part of |
| | | | | the positive |
| | | | | electrode |
| Comparative | Fail | Fail | Fail | Battery burnt |
| example 2 | | | | inside, analysis |
| | | | | cannot he made |

According to the present invention, the lithium belt negative electrode plate is provided with a reaction inhibiting region, and a polymer plastic tape 4 is provided on the reaction inhibiting region; a groove 5 is provided between the electrode tab 3 of the lithium belt negative electrode plate 2 and the polymer plastic tape 4 to stop reaction. The reaction inhibiting region according to the above configuration can ensure effective and sufficient battery discharge. The groove that stops reaction can ensure that the lithium belt is broken under overloaded battery discharge and forced battery discharge, thereby ensuring battery safety. The primary lithium battery according to the present invention is safe and has high discharge capacity.

In the above embodiments 1, 2 and 3, the material making the positive electrode can also be iron disulfide, and the same technical effect can be achieved.

The preferred embodiments of the present invention are described above. Any obvious changes and replacements without deviating from the inventive concept of the present invention should fall within the scope of protection of the present invention.

1: A primary lithium battery comprising a positive electrode plate, a separator, a lithium belt negative electrode plate, and electrode tabs disposed on the positive electrode plate and the lithium belt negative electrode plate respectively; the positive electrode plate, the separator, and the lithium belt negative electrode plate are mutually wound together as a winding, wherein an end of the electrode tab of the positive electrode plate is used as a starting end of the winding;
at a tail end of the winding, a reaction inhibiting region is provided on the lithium belt negative electrode plate; a polymer plastic tape is provided on the reaction inhibiting region;
a groove is provided between the electrode tab of the lithium belt negative electrode plate and the polymer plastic tape.

2: The primary lithium battery of claim 1, wherein the polymer plastic tape is any one of a polyimide tape, a polyolefin tape, a polyester tape, and a polyfluoro tape.

3: The primary lithium battery of claim 2, wherein an acrylic glue layer or a silica gel layer is provided between the polymer plastic tape and the lithium belt negative electrode plate.

4: The primary lithium battery of claim 3, wherein a width of the polymer plastic tape is 10% to 35% of a width of the lithium belt negative electrode plate; a length of the polymer plastic tape is 10% to 20% of a length of the lithium belt negative electrode plate.

5: The primary lithium battery of claim 1, wherein a depth of the groove is 40% to 90% of a thickness of the entire lithium belt negative electrode plate.

6: The primary lithium battery of claim 5, wherein a width of the groove is 0.1% to 7% of a length of the entire lithium belt negative electrode plate.

7: The primary lithium battery of claim 6, wherein a length of the groove is the same as or narrower than a width of the lithium belt negative electrode plate.

8. (canceled)

9. (canceled)

10. (canceled)
